(19) United States
(12) Patent Application Publication
(10) Pub. No.: US 2020/0023551 A1
(43) Pub. Date: Jan. 23, 2020

(54) Sanding device and method for preforms

(71) Applicant: Hans Lingl Anlagenbau und Verfahrenstechnik GmbH & Co. KG, Krumbach (DE)

(72) Inventor: Laurenz AVERBECK, Bad Iburg (DE)

(21) Appl. No.: 16/498,243

(22) PCT Filed: Mar. 5, 2018
(86) PCT No.: PCT/EP2018/055288

§ 371 Date: Sep. 26, 2019

(30) Foreign Application Priority Data
Mar. 29, 2017 (DE) 10 2017 205 335.6

(51) Int. Cl. B28B 11/04; B28B 11/06

(52) U.S. Cl. CPC B28B 11/045; B28B 11/06

(57) ABSTRACT

The invention describes a device for applying sand to preforms for wetting and sanding bricks prior to firing (preforms), in order to prevent sticking of the stacked bricks in the firing oven. The device consists of a sanding device in which the preforms are placed in order to wet and sand the contact surfaces in a targeted manner. In one embodiment, the sanding device consists of a liquid pan and a sanding pan for first wetting and then sanding the contact surfaces of the preforms. By means of the targeted and sustainable application of sand on a surface of preforms, it is ensured that sufficient sand is applied between the preforms as an intermediate layer in the firing oven, and scatter losses commonly caused by prior art sprinkling with sand from above. The device according to the invention not only saves sand, but also protects other system parts which are not designed to handle scattered sand. Also, the device according to the invention reduces dust generation during the sanding of preforms.

The invention relates to a device and a method for sanding preforms according to the preambles of the independent claims.

In the manufacture of bricks, it is commonly known to spread sand on the raw bricks or preforms after drying and prior to stacking in a firing oven so that the bricks do not stick together during the firing process.

It is known from the prior art to sprinkle or spread sand on the preforms. The sand is sprinkled onto the preform surface from above through sprinkling channels or other feeding devices, which are disposed perpendicular to the direction in which the bricks are conveyed. The sand then freely falls onto the bricks from just above the bricks.

The prior art cited above has a series of disadvantages, however. Since the preforms are located at defined distances away from one another on a transporting means, the distances depending on the manufacturing process, only some of the sand falls onto the brick surfaces, whereas a large residual amount falls onto the transporting means or the mechanical system, which leads to increased wear on the surfaces and moving parts. Moreover, the sand easily trickles off of the preforms before they are stacked on the firing cart since there is a very poor bond between the sand and the bricks, if there is a bond at all. In particular, the sanded bricks are guided, moved or raised using further machine parts, rotated in other process steps or transferred to other machine parts. Quite a bit of sand is lost due to these movements in the mechanical system by virtue of the sand falling off of the bricks. Therefore, there is often not much sprinkled sand left on the bricks by the time the preforms arrive at the firing cart.

As a result, this methodology incurs a high consumption of sand, makes it extremely difficult to achieve the right dosage of spread material and also has detrimental effects on the manufacturing section due to high levels of dust generation.

Therefore, the object of the present invention is to improve the prior art with regard to the disadvantages cited above. In particular, the object of the present invention is to apply the sand in a targeted fashion and in such manner as to hold the sand sufficiently on the bottom of the preforms so as to minimize scattering losses, prevent dust generation and to protect the transporting means. In addition, each brick should be coated with sand and in the process variations in sand coverage due to manufacturing conditions should be avoided.

The problems posed are solved by the features of the independent claims of the present invention. The features of the dependent claims provide further advantageous improvements to the inventive concept.

The present invention relates to a device for applying sand to preforms, comprising a sanding device for sanding the preforms, wherein the sanding device comprises a sanding pan which is at least partially filled with a fine-grained and heat-resistant material, and a transferring device, wherein the transferring device is suitable for placing the preforms into the sanding device and removing the sanded preforms from the sanding device.

Designing the transferring device to place preforms into a sanding pan after drying ensures that only a bottom side or contact area of the preforms is coated with finely-grained and heat-resistant material before the preforms are brought to a firing oven in further process steps. In this way, the disadvantageous effects of sprinkling preforms with sand is overcome, while at the same time later sticking of the preforms during firing in the firing oven is avoided.

It is advantageous that the sanding device further comprises a liquid pan for wetting the preforms.

In this embodiment, the liquid pan is located next to the sanding pan within reach of the transferring device and is used to wet the preforms.

Alternatively, the sanding pan is filled with a mixture of fine-grained and heat-resistant material and a liquid, and the transferring device is further adapted to place the preforms onto the surface of the mixture in order to both wet and sand the contact area of the preforms.

In this embodiment, there is no need for an additional liquid pan since the wetting and sanding can be done in a single step in the sanding pan.

In the case of the embodiment comprising a liquid pan, it is conceivable that the liquid pan is advantageously filled with a liquid and comprises a support for holding preforms, the support being adapted to wet the contact area of the preforms, and that the transferring device is further adapted to place the preforms first of all on the support, and then to grasp the preforms and to transfer them with the wetted contact areas into the sanding pan.

It is advantageous for the support to comprise a wetting material which can hold the liquid at the positions where the preforms are placed.

The wetting material serves the purpose of moisture storage involving the absorption of stored liquid from the liquid pan or a liquid basin and the release of the liquid again due to the contact pressure of the preforms, thereby wetting the contact area of the preforms with moisture. It is conceivable here for sponge or felt pads to be placed on the support, somewhat like a grille, at the positions where the preforms are to be placed. Alternatively, the wetting material can be part of the support, and can be woven or set into the support structure in order to prevent any floating of the wetting material when the support is lowered into the liquid pan. For this purpose, of course, it is conceivable for the wetting material to be fastened to the support.

Advantageously, the support is at least partially liquid-permeable for the liquid in the liquid pan and can be raised and lowered in the liquid pan in order for the wetting material to become soaked with the liquid.

Due to the permeability of the lowerable and raiseable support, which is somewhat like a grille, the soaking of the applied wetting material with the liquid from the liquid pan as needed is ensured when the support is lowered into the liquid pan.

It is advantageous for the support to be at least partially a grille.

It is advantageous for the wetting material to comprise an outline which is at most equal to the contact surface of the preforms so as to avoid wetting the visible side surfaces of the preforms.

In one embodiment, the outline of the wetting material is adapted such that only parts of the contact surface are wetted so that only these parts of the contact surface are sanded.

The geometry of the wetting material is the deciding factor as to which portion of the contact surface of the preforms is wetted with liquid. It could be desirable for the outline of the wetting material to be structured such that only the contacting edge of the preforms is wetted in the form of a strip-like border or any other region of contact area. In particular, the above shaping of the wetting material can ensure that no parts thereof protrude out over the edge of the contact surfaces of the preforms. In this way, areas of the visible side surfaces of the preform are prevented from being wetted since this can lead to undesirable discoloration.

It is advantageous for the wetting material to be made of sponge, felt or another absorbing or adsorbing material.

It is advantageous for the liquid to have a viscosity and/or surface tension suitable for soaking the wetting material and wetting the contact area of the preforms.

It is advantageous for the liquid to consists of water, wallpaper paste, oil, glue or another liquid which enables adhesion of sand from the sanding pan to the preforms.

This helps the wetting material to absorb and hold a liquid in order for the liquid to be released to the contact surface of a preform upon contact therewith. Also, the structure of the wetting material using said material and the material properties of the liquid ensure that the liquid is temporarily stored in the wetting material and does not prematurely evaporate or leak out. Furthermore, by means of advantageous material properties of the liquid, the preform is well wetted thereby and fine-grained and heat-resistant material (sand) adheres well thereto.

Instead of wetting material, the use of rollers is also conceivable for wetting the preforms.

In this alternative embodiment, the liquid pan is advantageously filled with a liquid and comprises at least one roll for accommodating preforms, wherein the at least one roll wets the contact surface of the preforms by making a rolling motion. Furthermore, the transferring device is adapted to guide the contact surface of the preforms over the rolls in a kinematic link to the rolling motion of the at least one roll and to transfer the preforms with the wetted contact area into the sanding pan.

It is advantageous for the at least one roll to be disposed in the liquid.

Alternatively, the liquid pan comprises additional rolls which are located in the liquid and are coupled to one of the at least one rolls, respectively, in a kinematic link so as to wet the at least one roll by means of the rolling motion.

In this embodiment, the preforms are wetted using rolls which are not located in the liquid but which are in turn wetted by rolls located in the liquid by means of roll contact.

It is advantageous for the rolls to consist at least partially of a sponge-like material or another absorbing or adsorbing material.

Instead of wetting material or rolls for wetting the preforms, another alternative embodiment of a liquid pan comprises upwardly-directed nozzles which are suitable for spraying the contact area of the preforms with a liquid. In this other alternative embodiment, the liquid pan is not filled with a liquid, but provides the space for feeding in liquid lines and takes up excess liquid. Furthermore, the transferring device is adapted to hold the contact area of the preforms above the nozzles and to transfer the bricks with the wetted contact surface into the sanding pan.

It is advantageous that the sanding device comprises a shaking mechanism to smooth the fine-grained and heat-resistant material.

A shaking mechanism is conceivable in all embodiments, with or without additional liquid basins since the surface of a mixture of liquid and sand can also be shaken in a sanding pan and made smooth.

It is advantageous for the sanding device to comprise a rake or doctor blade in the sanding pan in order to smooth over the surface of the at least partially fine-grained and heat-resistant material and to remove clumps in the fine-grained and heat-resistant material.

It is conceivable for a rake or doctor blade extending over the entire width of the sanding pan to be provided with a suitable transport device and mount, to pull the rake or blade over the sanding pan and thereby to rake through the surface of the sanding pan filling. It is also conceivable to use a doctor blade to draw the surface of the sanding pan fill if the use of a rake is not seen as advantageous, in particular if a mixture of liquid and sand is provided in the sanding pan. In the process, it is conceivable that both ends of the rake or the doctor blade protrude beyond the sanding pan at opposite sides thereof and are fastened there to a conveyor belt (for example a closed continuous belt) placed over two pulleys, the conveyor belt in turn moving the rake or doctor blade over the length of the sanding pan.

It is advantageous for the transferring device to be adapted to remove the preforms from a feeding device prior to placement in the sanding device and to place them onto a firing cart after removal from the sanding device.

In this way, the process step of sanding can be decoupled from the transport path in order to limit the scattering of sand or corresponding fine-grained material onto the area of the sanding device.

The invention further relates to a method for applying sand to preforms, the method comprising the steps of: placing the preforms onto the surface of a partially fine-grained and heat-resistant material located in a sanding pan of the sanding device in order to sand the contact surface of the preforms.

The method according to the invention has the same advantages as the sanding device according to the invention.

The present invention is described in detail below with reference to the attached drawings.

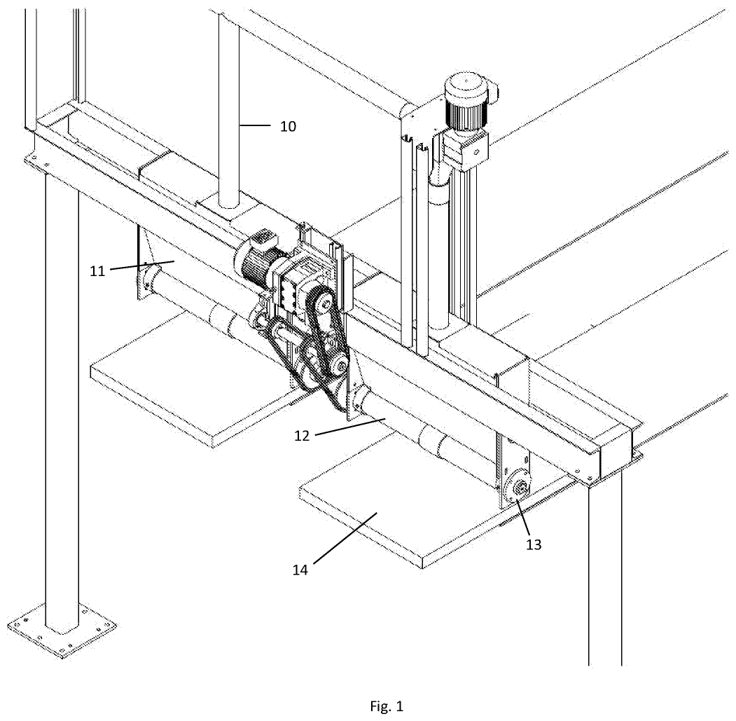

FIG. 1 shows a view of a device for sanding preforms according to the prior art.

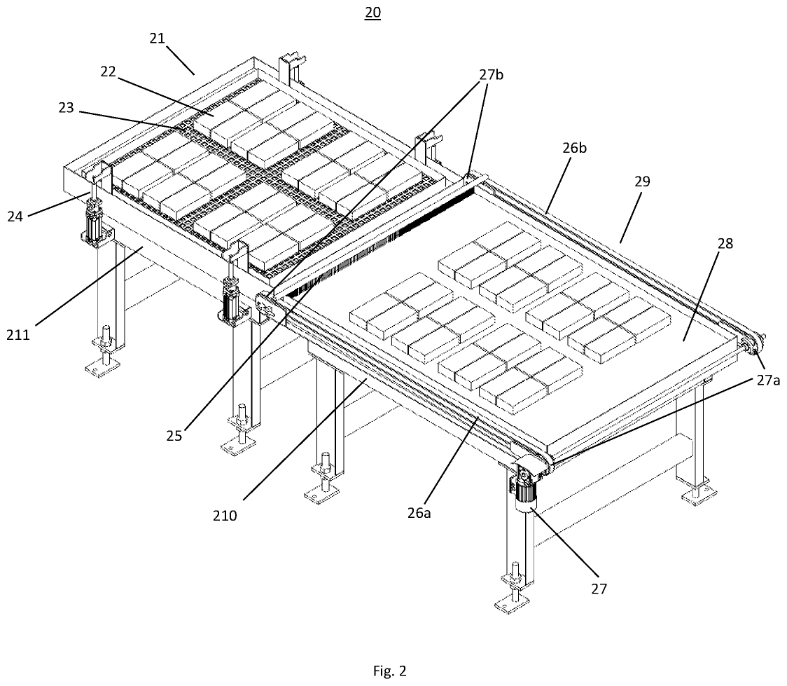

FIG. 2 shows the device according to the invention for sanding preforms, comprising a liquid pan and sanding device.

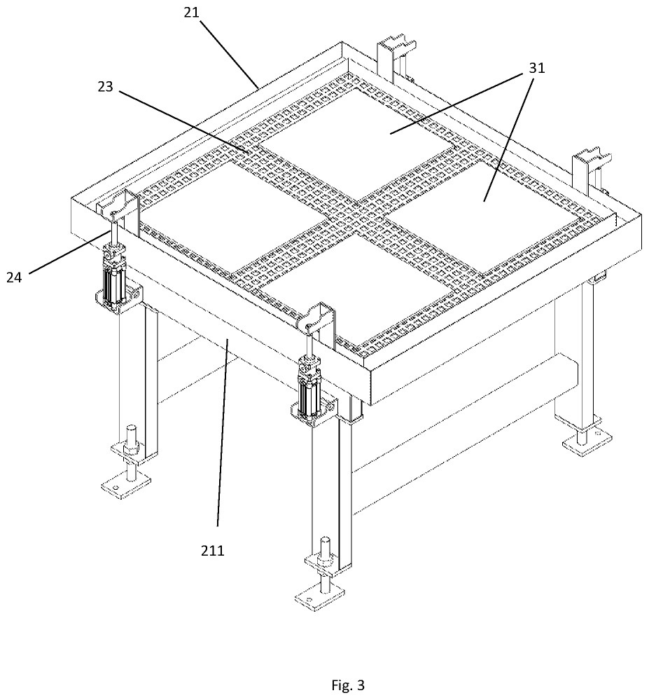

FIG. 3 shows a detailed sketch of an embodiment of the liquid pan according to the invention with a support and wetting material.

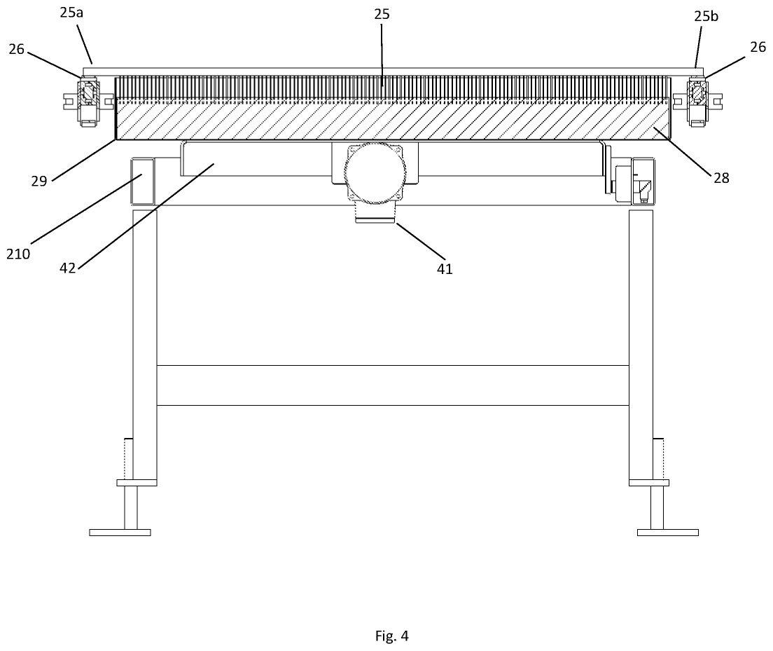

FIG. 4 shows a detailed sketch of an embodiment of the sanding pan according to the invention in a side view.

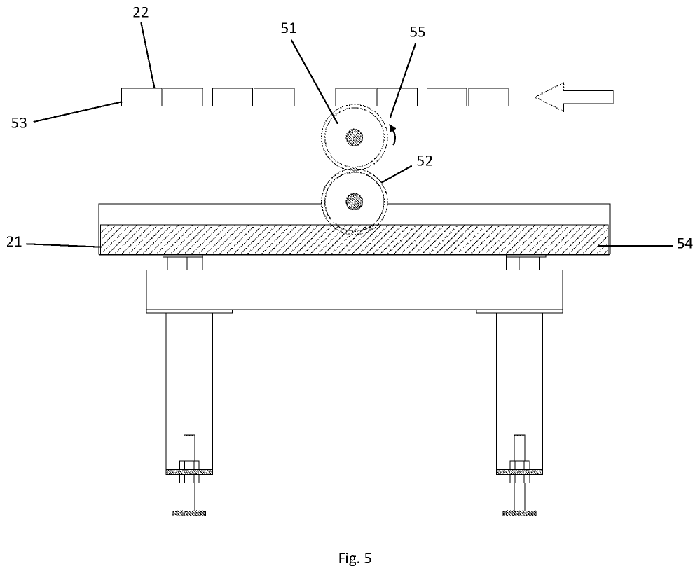

FIG. 5 shows a detailed sketch of an embodiment of the liquid pan according to the invention with wetting rolls.

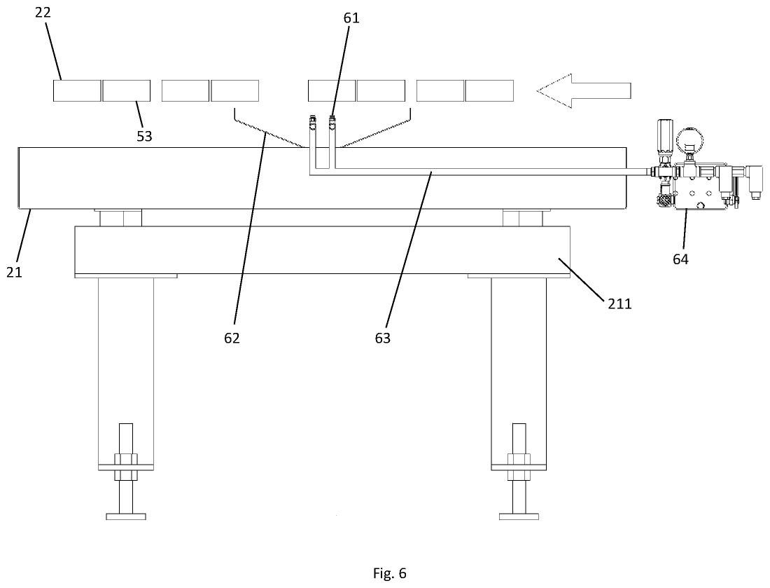

FIG. 6 shows a detailed sketch of an embodiment of the liquid pan according to the invention with spray nozzles for wetting the preforms.

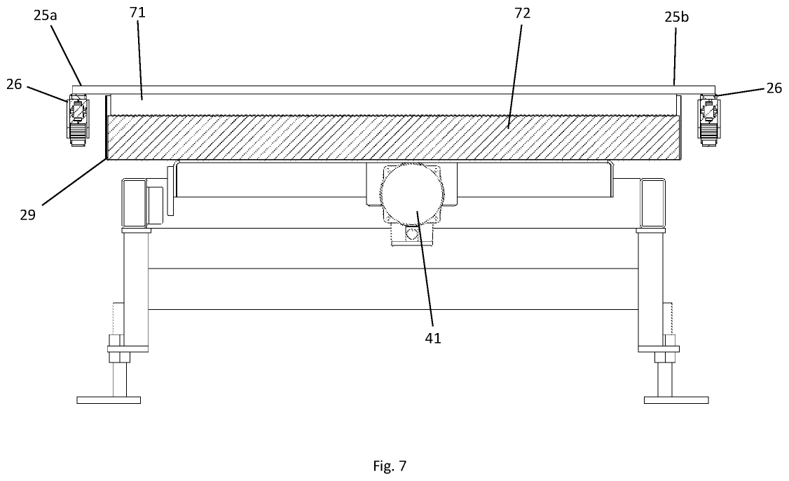

FIG. 7 shows a detailed sketch of an embodiment of the sanding pan according to the invention and filling with a sand-liquid mixture in a side view.

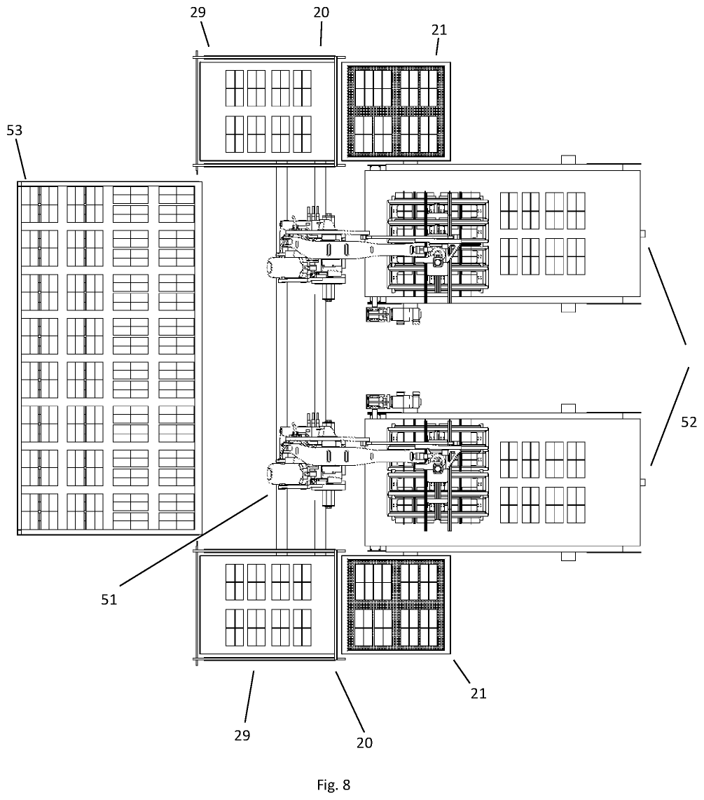

FIG. 8 shows a top view of an embodiment of the device according to the invention for sanding preforms in the context of a system for manufacturing bricks.

FIG. 1 shows a sanding system according to the prior art. The sand is scattered onto the preforms from above here. For this purpose, in this system example the sand is fed to collection receivers 11 by way of feed lines 10, the receivers narrowing downward and feeding the sand to a cylindrical drum 12 which is attached lateral to the brick feeder. A brush 13 which is suspended in the drum rotatably about the longitudinal direction of the drum is caused to rotate by means of a drive mechanism, then takes up the sand and distributes it as evenly as possible over the length of a slotted opening located at the lower end of the drum. From there, the sand trickles by gravity onto the work piece to be sanded located on a conveyor belt 14 or another conveying device for this purpose.

FIG. 2 shows an embodiment of the device 20 according to the invention for sanding preforms. The device 20 consists of a liquid pan 21 and a sanding pan 29, wherein both pans are suitable for holding preforms 22. The liquid pan 21 is at least partially filled with a liquid 54 (see FIG. 5) and the sanding pan 29 is at least partially filled with heat-resistant and fine-grained material 28 (such as sand, see FIG. 4). In one embodiment, the liquid- and/or sanding pan are located on height-adjustable support tables 210 and 211, respectively, which can be fixed to the system base so that a suitable height level of the upper edges of the liquid and/or sanding pan can be established. For example, it can be desirable for the sanding pan 29 and/or the liquid pan 21 to be adjusted with respect to positional height of the preforms to an existing height level of a manufacturing facility for processing preforms.

A support 23 for holding the preforms 22 is provided for the liquid pan 21, wherein the outer dimensions of the support 23 are such that it fits into the liquid pan 21. In the process, it must be noted that the support 23 is designed as a grille so that dipping into the liquid can be easily done. Other embodiments are conceivable for the support which ensure sufficient support strength, torsional stiffness and permeability for liquids. Moreover, FIGS. 2 and 3 show that support 23 can be raised and lowered in the liquid pan 21 using vertical pistons 24 in the liquid pan.

Of course, the invention can also be operated using other lifting devices.

The purpose of lowering and raising the support 23 is to soak the wetting material 31 located at the positions of the placed preforms 22 with liquid from the liquid pan 21. After a series of wetting cycles, the support 23 is lowered into the liquid in order to again soak the wetting material 31, which consists of pads in one embodiment, with sufficient liquid.

For the sanding pan 29 of the sanding device 20, an at least partial filling with sand 28 or another heat-resistant and fine-grained material is provided. In this sense, “sand” in the description text is intended to mean any fine-grained and heat-resistant substance which serves the purpose of the invention of suitably sanding the preforms prior to firing so as to avoid sticking of the preforms and firing of the fine-grained intermediate layer in the firing oven.

After the preforms 22 are wetted in the liquid pan 21, using a transferring device 51 they are placed into the sanding pan 29 with the wetted contact area 53 facing downward. Simply by virtue of the contact pressure of the preforms alone in the sanding pan 29, the contact areas of the preforms 22 are coated with sand and can then be removed by the same or by another transferring device and placed in a suitable preparation area for further handling (e.g. firing).

FIG. 3 shows an embodiment of the liquid pan 21 without any preforms placed therein. Shown are areas 31 on the support which can be designed as absorbent pads and designed as wetting material at the positions of the preforms.

Alternatively, it is also conceivable that the wetting material 31 is a component of the otherwise grille-like support 23 in that the wetting material is embedded in the support structure 23 as pad-like surfaces. What is critical to the execution of the invention is that the material properties, geometry and output of the wetting material 31 at or in the support is designed such that the contact area of the preforms on the support is wetted in a desired form and with a sufficient amount of liquid from the liquid pan 21.

In the embodiment shown, the size of the wetting surfaces 31 or pads is large enough to wet the contact areas of entire groups of preforms.

However, in another embodiment, it is also conceivable that the wetting surfaces are further subdivided in order to only accommodate at least one preform.

With regard to the material properties of the wetting material 31, sponge- or felt-like materials are advantageous, wherein other absorbable or adsorbable materials can of course also be used.

With regard to the geometry of the wetting material 31, in one embodiment it is provided that the wetting material has an outline which is encompassed by the contact area of a preform in order to prevent wetting of the visible side surfaces of the preforms. In this case, the wetting material disappears in the top view below the outline of the placed preform. With regard to this basic geometry, other conceivable outlines of the wetting material are those in which only parts of the contact area are wetted, for example only an outer edge of the contact area. But it is also conceivable that the outlines of the wetting material extend beyond the outline of a placed preform in order to wet a plurality of preforms using a pad 31.

In order to repeatedly soak the wetting material 31 with liquid after a few wetting passes, the support 23 is lowered into the liquid pan 32 of liquid pan 21 without any preforms in the support until the wetting material 31 is dipped into the liquid. For this purpose, liquids such as water, wallpaper paste, oil or glue can be used. In this regard, it is within the scope of expert actions to select a liquid whose properties are such as to sufficiently soak the wetting material 31 on the one hand and on the other hand to well wet the contact area of the preforms. Moreover, a liquid must be selected which facilitates adhesion of the fine-grained and heat-resistant material to the preform.

FIG. 4 shows a detailed schema of an embodiment of the sanding pan 29 according to the invention in a side view. The same reference signs in the figures refer to the same elements of the invention in FIGS. 2 and 3. In this embodiment, the sanding pan 29 comprises a shaking mechanism 41 and a rake device 25 for flattening the sand filling 28 and to remove clumps. In order to achieve an even sanding, a sufficiently smooth and homogeneous sand surface is required. To this end, in this embodiment the sanding pan 29 comprises a pair of conveyor belts 26 at the right and left side walls, respectively, the ends 25a and 25b of the rake 25 being attached at said side walls. A suitable motor 27 drives the conveyor belts 26a and 26b using drive rolls and pulleys, which are advantageously connected in pairs to an axle, the motor pulling the rake 25 across the sand surface to remove clumps from the sand and homogenizing the sand. For the purposes of removing clumps from the sand pan 29, other devices such as skirts or doctor blades are conceivable which are pulled over the sand surface.

With regard to smoothing the sand surface, a shaking mechanism is provided in this embodiment which sporadically shakes the sanding pan 29 in order to smooth the sand surface. To this end, an embodiment is provided for connecting the sanding pan 29 in positively-locking fashion to a shaking table 42 which in turn is connected to a shaking motor 41 but which is decoupled from the support table 210 by way of a suitable suspension and damping.

In another embodiment, it is further conceivable to use the shaking mechanism to also remove clumps in the sand. Suitable shaking not only leads to smoothing of the sand surface, but also to clumps of fine sand being removed and floating to the top. It can be advantageous to keep the length of the rake teeth short since the sand filling then only has to be raked through on the surface.

FIG. 5 shows a detailed sketch of an embodiment of the liquid pan 21 according to the invention with rolls 51 and 52. Instead of wetting pads, in this embodiment wetting rolls are used which have sponge-like surfaces, the rolls—by way of a friction-lock connecting to the bottom sides 53 of the preforms—cause a wetting of the contact areas of the preforms, the areas then being placed into the sanding pan 29. In the embodiment shown, the bottom sides 53 and the rolls 51 and 52 are coupled together under friction so that the direction of motion of the preforms under friction with the upper wetting roll 51 leads to a rotation of the wetting roll 51 which in turn brings about a rotation of another liquid roll 52 dipped in the liquid. In this way, a push or pull movement of the preforms which is executed by a transferring device leads to a sustained wetting of the contact areas of the preforms since the wetting material or the sponge-like surface of the wetting roll 51 is kept wet by the sponge-like surface of liquid roll 52 as long as the preform is pushed, pulled or led over the surface of the wetting roll. Of course, embodiments are conceivable in which multiple wetting and liquid roll pairs are used in order to improve the wetting of the preforms, for example. In an alternate embodiment, only rolls are used, all of which rotate in the liquid.

Another alternate embodiment for a liquid pan is shown in FIG. 6 in which the use of a spray device for wetting the contact areas of the preforms is shown. In this embodiment, the liquid basin functions as a collection basin for receiving the descending spray fog and excess liquid dripping from the bottom side of the preforms. It is not necessary to fill the liquid basin since the liquid is introduced to outlet openings 61 by way of feed lines 63 at a pressure sufficient enough to exit upward from there and to wet the contact areas of the preforms with liquid. The embodiment shown involves liquid nozzles 61 which create a spray fog and thereby ensure an even and sparse wetting of the bottom sides 53 of the preforms. In another embodiment, a collection bowl 62 placed above the pan accommodates the descending spray fog or liquid excess and routes the same to liquid pan 21.

In all embodiments of the liquid basin, it is conceivable that the liquid pan 21 is located on support tables 211 which are height-adjustable and fixable to the system base in order, as already described, to adjust a suitable height level of the upper edges of the liquid pan relative to the rest of the sanding system as shown in FIG. 8.

The sanding of the preforms 22 according to the invention is also achievable by performing the wetting and sanding in a single work step. From the position of the device, this idea is realizable in an embodiment shown in FIG. 7. In order to carry out the sanding of the preforms in a single work step, the sanding pan 29 is filled with a liquid-sand mixture onto which the preforms are placed by the transferring device 51. In this embodiment, therefore, there is no need for a liquid pan 21.

It is advantageous for the liquid-sand mixture 72 to consist of a mixture of sand, oil and paste. However, in order to achieve a satisfactory wetting of the preforms with the liquid-sand mixture, many material combinations and mixture ratios are conceivable. Also, the liquid itself is in turn conceivable as a homogeneous or a heterogeneous mixture.

As in the embodiment already shown in FIG. 4, a shaking mechanism 41 is also conceivable in this embodiment of a sanding pan 29, as well as a rake device 71 or doctor blade device 71 for smoothing the liquid-sand mixture 72 and to remove clumps. It is advantageous for this embodiment to comprise a doctor blade 71 instead of a rake if the toughness or heterogeneity of the liquid-sand mixture does not allow for raking. Here, the doctor blade 71 comprises a sufficiently stiff lip which can be pulled over the liquid-sand mixture 72 in order to strip away clumps. If the properties of the liquid-sand mixture 72 allow it, it is also conceivable to use the doctor blade to smooth the mixture surface. In this case, then, there is no need for a shaking mechanism 41.

FIG. 8 shows a possible system overview, with transferring devices 51 in a top view in which the device according to the invention can be used for sanding preforms. In this embodiment, the transferring device 51 is shown as a pair of transfer robots, but any other device suitable for transferring preforms from a liquid pan 21 with identical contact surfaces to a sanding device 29 is conceivable as an embodiment. Furthermore, in this embodiment the transferring devices 51 are designed to remove the preforms from a feeder prior to insertion into the liquid pan and after removal from the sanding device to feed the bricks to a firing cart. For this purpose, the transfer robot 51 removes the preforms from a preparation line 52 and places them in a preparation area 53 or onto a firing cart 53 after sanding according to the invention.

In summary, the invention discloses a device 20 for sanding preforms, the device wetting and sanding the bricks 22. The preforms are held by a support 23 sufficiently long over the liquid surface of a liquid pan 21 for the contact areas to be wetted with the liquid from the soaked wetting pads 31. Then, the preforms are placed in a sanding device 29 using a suitable transferring device 51 having the same contact area so that the contact areas of the preforms previously wetted can now be coated with sand.

By applying sand to a surface of preforms in a targeted and sustainable manner, the application of a sufficient intermediate layer of sand between the preforms in the firing oven is ensured and the scatter losses in the rest of the system for manufacturing bricks are avoided. This saves sand and as much as possible protects other system parts which are not designed to handle scattered sand. Also, a considerable reduction in dust generation can be expected.

1. A device for applying sand to preforms, comprising
a sanding device for applying sand to the preforms, wherein the sanding device comprises a sanding pan which is filled at least partially with a fine-grained and heat-resistant material; and
a transferring device for placing the preforms into the sanding device in order to apply sand to the contact surfaces of the preforms and to remove the sanded preforms from the sanding device.

2. The device according to claim 1, the sanding device further comprising a liquid pan for wetting the preforms.

3. The device according to claim 1, the sanding pan filled with a mixture of fine-grained and heat-resistant material and a liquid, and the transferring device adapted to place the preforms onto the surface of the mixture in order to substantially simultaneously wet and sand the contact surface of the preforms.

4. The device according to claim 2, the liquid pan filled with a liquid and comprising a support for holding preforms which is adapted to wet the contact surface of the preforms, and the transferring device adapted to first place the preforms onto the support, then to grasp the preforms and transfer them with the wetted contact surface to the sanding pan.

5. The device according to claim 4, the support comprising a wetting material which can hold the liquid at the positions where the preforms are placed.

6. The device according to claim 5, the support at least partially liquid-permeable in the liquid in the liquid pan and raisable and lowered in the liquid pan in order for the wetting material to become soaked with the liquid.

7. The device according to claim 4, the support is at least partially a grille.

8. The device according to claim 5, the wetting material having an outline which at most is equal to the contact surface of the preforms in order to avoid wetting the visible side surfaces of the preforms.

9. The device according to claim 8, the outline of the wetting material adapted such that only parts of the contact surface are wetted so that only these parts of the contact surface are sanded.

10. The device according to claim 5, the wetting material made of sponge, felt or another absorbing or adsorbing material.

11. The device according to claim 3, the liquid having at least one of a viscosity or surface tension which is suitable for soaking the wetting material and for wetting the contact surface of the preforms; or
the liquid including water, wallpaper paste, oil, glue or another liquid which enables an adhesion of the fine, rained and heat-resistant material from the sanding pan onto the preforms.

12. (canceled)

13. The device according to claim 2, the liquid pan filled with a liquid and comprising at least one roll for accommodating preforms, wherein the at least one roll wets the contact surface of the preforms by making a rolling motion, that the transferring device adapted to guide the contact surface of the preforms over the at least one roll in a kinematic link to the rolling motion and to transfer the preforms with the wetted contact area into the sanding pan.

14. The device according to claim 13, the at least one roll is located in the liquid.

15. The device according to claim 13, the liquid pan further comprising rolls located in the liquid and coupled to one of the at least one rolls, respectively, in a kinematic link so as to wet the at least one roll by means of the rolling motion.

16. The device according to claim 13, the rolls including a sponge-like material or another absorbing or adsorbing material.

17. The device according to claim 2, the liquid pan comprising upwardly-directed nozzles (61) for spraying the contact area of the preforms with a liquid the transferring device adapted to hold the contact surface of the preforms above the nozzles and to transfer the preforms with the wetted contact surface into the sanding pan.

18. The device according to claim 1, the sanding pan comprising a shaking mechanism to smooth the fine-grained and heat-resistant material.

19. The device according to claim 1, the sanding device comprising a rake or doctor blade which can move in the sanding pan to smooth over the surface of the at least partially fine-grained and heat-resistant material and to remove clumps in the at least fine-grained and heat-resistant material.

20. The device according to claim 1, the transferring device is also adapted to remove the preforms from a feeding device prior to placement in the sanding device and to place the preforms onto a firing cart after removal from the sanding device.

21. A method for applying sand to preforms, the method comprising; placing the preforms onto the surface of a partially fine-grained and heat-resistant material located in a sanding pan of sanding device in order to sand the contact surface of the preforms.
